(19) United States
(12) Patent Application Publication
(10) Pub. No.: US 2024/0368791 A1
(43) Pub. Date: Nov. 7, 2024

(54) ADDITIVE MANUFACTURING OF CURRENT COLLECTORS FOR ELECTRODES OF BATTERY CELLS

(71) Applicant: GM GLOBAL TECHNOLOGY OPERATIONS LLC, Detroit, MI (US)

(72) Inventors: Mitra SHABANISAMGHABADY, Royal Oak, MI (US); Diptak Bhattacharya, Royal Oak, MI (US); James Joseph Deininger, Wyandotte, MI (US); Caleb Reese, Milford, MI (US); Hassan Ghassemi-Armaki, Northville, MI (US)

(21) Appl. No.: 18/309,902

(22) Filed: May 1, 2023

(51) Int. Cl. C25D 1/00; B33Y 10/00; B33Y 80/00; H01M 4/66; H01M 4/74

(52) U.S. Cl. CPC C25D 1/003; B33Y 10/00; B33Y 80/00; H01M 4/661; H01M 4/74

(57) ABSTRACT

A method for manufacturing a current collector for an electrode of a battery cell includes forming the current collector using a metal 3D printing process; defining L layers of the current collector, where L is an integer greater than zero during the 3D printing of the current collector; and defining a lattice structure in at least one of the L layers of the current collector during the 3D printing of the current collector.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to current collectors for electrodes of battery cells, and more particularly to additive manufacturing of current collectors for electrodes of battery cells.

Electric vehicles such as battery electric vehicles and hybrid vehicles are powered by a battery pack including one or more battery modules each including one or more battery cells. The battery cells include anode electrodes, cathode electrodes, and separators. The anode electrodes typically include anode active layers arranged on opposite sides of an anode current collector. The cathode electrodes typically include cathode active layers arranged on opposite sides of a cathode current collector.

### SUMMARY

A method for manufacturing a current collector for an electrode of a battery cell includes forming the current collector using a metal 3D printing process; defining L layers of the current collector, where L is an integer greater than zero during the 3D printing of the current collector; and defining a lattice structure in at least one of the L layers of the current collector during the 3D printing of the current collector.

In other features, the metal 3D printing process prints at least a portion of the current collector using one or more materials selected from a group consisting of copper, stainless steel, nickel, iron, titanium, tin, and/or alloys thereof. At least one of the L layers includes a planar layer, wherein at least another one of the L layers is printed on the planar layer. The current collector has a thickness in a range from 10 μm to 300 μm. The metal 3D printing process comprises electrochemical additive manufacturing (ECAM). The current collector comprises an anode current collector and the metal 3D printing process prints the current collector using at least one of copper and a copper alloy. The current collector includes a planar layer and the lattice structure includes a first lattice structure printed on one side of the planar layer and a second lattice structure printed on an opposite side of the planar layer.

In other features, the method includes coating the current collector with an active material layer to form one of an anode electrode and a cathode electrode. The method includes at least one of pressing and heating the current collector and the active material layer. The metal 3D printing process prints at least a portion of the current collector using two or more metals selected from a group consisting of copper, stainless steel, nickel, iron, titanium, tin, and/or alloys thereof. The current collector is printed on a substrate. The substrate is selected from a group consisting of a polymer layer, a plastic layer, a metal layer, a ceramic layer, and a thin film. The substrate comprises foil.

A method for manufacturing a current collector for an electrode of a battery cell, comprising providing a substrate having a surface with a predetermined profile; forming the current collector using a metal 3D printing process; during the 3D printing of the current collector, defining L layers of the current collector, where L is an integer greater than zero; during the 3D printing of the current collector, defining a lattice structure in at least one of the L layers of the current collector; and dissolving the substrate.

In other features, the metal 3D printing process prints at least a portion of the current collector using one or more materials selected from a group consisting of copper, stainless steel, nickel, iron, titanium, tin, and/or alloys thereof. At least one of the L layers includes a planar layer, wherein at least another one of the L layers is printed on the planar layer. The metal 3D printing process comprises electrochemical additive manufacturing (ECAM). The method includes coating the current collector with an active material layer. The method includes at least one of pressing and heating the current collector and the active material layer to form one of an anode electrode and a cathode electrode.

A current collector comprises L layers made of at least one of copper and copper alloy, where L is an integer greater than zero. The current collector further comprises a lattice structure formed using 3D metal printing in least one of the L layers of the current collector.

An anode electrode of a battery cell includes an anode current collector comprising L layers made of at least one of copper and copper alloy, where L is an integer greater than zero. At least one of the L layers of the current collector includes a lattice structure formed using 3D metal printing. An anode active layer is arranged on at least one side of the anode current collector.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell including anode electrodes including anode current collectors and anode active material, cathode electrodes including cathode current collectors and cathode active material, and separators;

FIG. 2A is a perspective view of an example of a current collector made using metal 3D printing according to the present disclosure;

FIG. 2B is an exploded perspective view of an example of a current collector made using metal 3D printing according to the present disclosure;

FIGS. 2C to 2F are enlarged views of examples of current collectors with lattice structures that are made using metal 3D printing according to the present disclosure;

FIGS. 3A and 3B is a perspective view of an example of a current collector made using metal 3D printing according to the present disclosure;

FIG. 4 is a perspective view of an example of a current collector made using metal 3D printing according to the present disclosure;

FIG. 5A is a side cross section of an example of a current collector made using metal 3D printing onto a substrate according to the present disclosure;

FIG. 5B is a side cross section of the current collector of FIG. 5A after the substrate is dissolved according to the present disclosure;

FIG. 6A is a side cross section of an example of an electrode including a current collector and one or more active material layers according to the present disclosure;

FIG. 6B is a side cross sectional view of a current collector including a lattice structure made using metal 3D printing on a substrate according to the present disclosure;

FIG. 7A is a flowchart of an example of a method for manufacturing a current collector using metal 3D printing according to the present disclosure; and

FIG. 7B is a flowchart of an example of a method for manufacturing a current collector using metal 3D printing according to the present disclosure.

In the drawings, reference numbers may be reused to identify similar and/or identical elements.

### DETAILED DESCRIPTION

While additive manufactured current collectors are described in the context of electrodes for battery cells of electric vehicles, the current collectors can be used for electrodes of battery cells used in stationary applications or other applications.

The present disclosure relates to current collectors for electrodes of battery cells. The current collectors according to the present disclosure are created using additive manufacturing (e.g., metal 3D printing). Current collectors are typically made using metal foils, wire mesh, or expanded metal. However, the structure of these current collectors is relatively fixed and cannot be customized easily with current manufacturing processes such as extrusion, rolling, weaving, laser etching, etc.

Current collectors according to the present disclosure are manufactured using a metal three dimensional (3D) printing process (e.g., electrochemical additive manufacturing (ECAM)) to create current collectors that have lattice structures or other customized, repeating, and highly controlled shapes and/or surfaces.

Traditional 3D printing processes solidify material by melting the material or using UV light to crosslink monomers. Using UV initiated crosslinking is only applicable for polymers and not metals. For metals, the printed material needs to be heated to a very high temperature.

However, ECAM uses an electroplating process. Metal ions are supplied in a solution (e.g., Cu²⁺ ions in copper sulfate) that is printed. A meniscus is formed between a nozzle of the print head supplying the solution and a conductive plate. A potential is then applied to deposit the metal and the print head is moved to the next print coordinate. This process is repeated until a 3D object is printed.

Current collectors according to the present disclosure include lattice structures with highly controlled, repeating geometric shapes. The ability to finely control features of the current collector allows precise control of parameters such as porosity, surface density, material adhesion (i.e., lithium), surface roughness, and/or current distribution. Current collectors manufactured using metal 3D printing improve the performance of the battery cells.

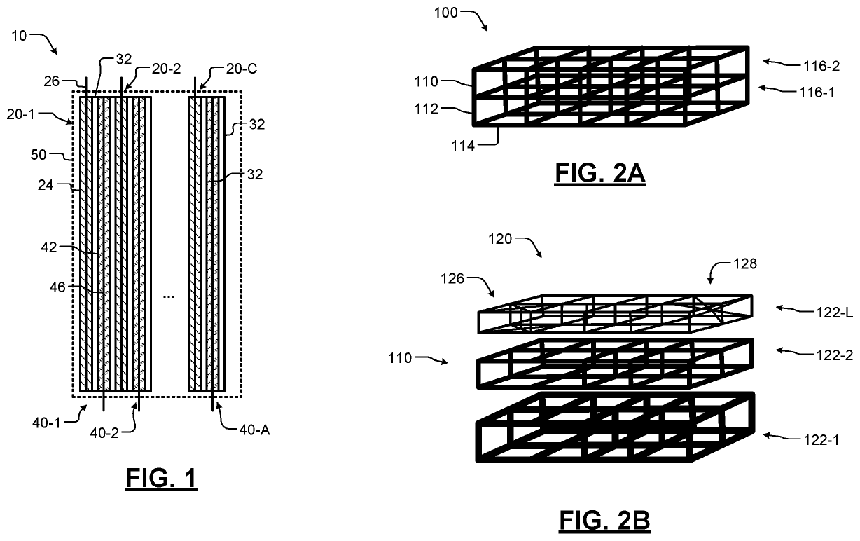

Referring now to FIG. 1, a battery cell 10 includes C cathode electrodes 20-1, 20-2, . . . , and 20-C, where C is an integer greater than zero. The C cathode electrodes 20 include cathode active layers 24 arranged on one or both sides of cathode current collectors 26. The battery cell 10 includes A anode electrodes 40-1, 40-2, . . . , and 40-A, where A is an integer greater than zero. The A anode electrodes 40 include anode active layers 42 arranged on one or both sides of anode current collectors 46. S separators 32 are arranged between pairs of the A anode electrodes 40 and the C cathode electrodes 20, respectively, where S is an integer greater than zero. The C cathode electrodes 20, the A anode electrodes 40 and the S separators 32 are arranged in a predetermined order in an enclosure 50. The current collectors described below can be used in anode electrodes or cathode electrodes.

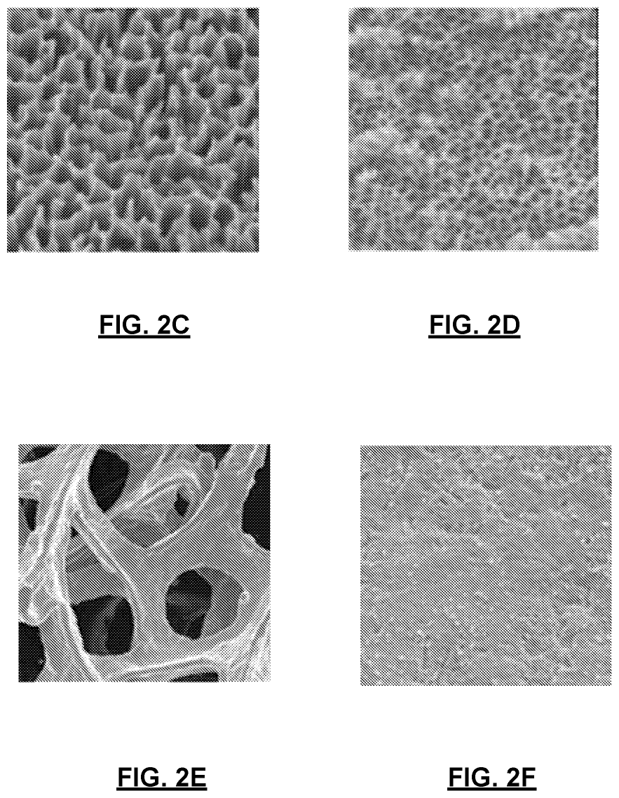

Referring now to FIG. 2A to 3B, various examples of current collectors that are metal 3D printed are shown. In FIG. 2A, a current collector 100 includes a lattice structure 110 including one or more layers with one or more interleaved, repeating and/or interconnected shapes. In some examples, the current collector 100 includes legs 112 and 114 (e.g., vertical and/or horizontal legs) that are connected to define one or more repeating shapes (e.g., a cube in FIG. 2A).

In FIG. 2A, the current collector 100 includes two layers 116-1 and 116-2 having a similar lattice structure. However, the current collector 100 can include a single layer. The lattice structure 110 of the current collector 100 can include two or more repeating shapes that are interleaved, repeated, and/or interconnected. While the lattice structure 110 is shown to include a repeating pattern of cubes or rectangles, the lattice structure 110 can include one or more shapes such as polygons, circular, elliptical, or arcuate shapes, organic shapes, irregular shapes, and/or any other shapes.

Varying the shape of the lattice structure, the thickness of legs of the lattice structure, the thickness and/or numbers of layers of the lattice structure, the repeating shape of the lattice structure, and/or other dimensions of the lattice structure allows increased control over parameters of the current collector such as porosity, surface roughness, surface density, material adhesion (i.e., lithium), resistance, and/or current distribution of the current collector 100.

In some examples, metal materials used for 3D printing can be varied from one layer to another or within a given layer. For example, the current collector 100 can be made of one or more materials selected from a group consisting of copper, stainless steel, nickel, iron, titanium, tin, and/or alloys thereof. In some examples, alternating layers of copper and aluminum are printed to create a current collector such as a bipolar current collector. Alternatively, layers of different grades of materials, such as copper or stainless steel, are printed to enhance properties, increase sustainability, and/or decrease overall cost of raw materials.

In FIG. 2B, an exploded view of a current collector 120 is shown to include a lattice structure 121 including L layers 122-1, 122-2, . . . , and 122-N, where L is an integer greater than one. In the example in FIG. 2B, L=3. In some examples, all of the layers 122 have the same configuration. In other examples such as the current collector in FIG. 2B, one or more of the L layers 122-1, 122-2, . . . , and 122-N is different than others of the L layers. For example, the layer 122-1 has thicker horizontal and/or vertical legs as compared to the layers 122-2 and/or 122-L. For example, the thickness of the N layers 122-1, 122-2, . . . , and 122-L can be varied. For example, the layer 122-1 is vertically thicker than the layer 122-2 and/or the layer 122-2 is vertically thicker than the layer 122-L. Portions of the lattice structure 121 in one or more of the layers L layers 122-1, 122-2, . . . , and 122-L can be varied (e.g., lattice portions 126 and 128 in the layer 122-L are different). In some examples, the thickness of a layer is in a range from 10 μm to 300 μm (e.g., 80 μm).

In FIGS. 2C to 2F, other examples of current collectors with different lattice structures are shown.

In FIG. 3A, a current collector 130 includes a planar layer 134 and a lattice structure 110 printed on the planar layer 134 (or substrate). The planar layer 134 can be 3D printed prior to the lattice structure 110 and/or manufactured in using another approach. For example, the planar layer 134 can include a foil and the lattice structure is metal 3D printed on the foil.

In FIG. 3B, a current collector 150 includes a planar layer 134 and lattice structures 132-1 and 132-2 printed on opposite sides of the planar layer 134. The planar layer 134 can be 3D printed prior to the lattice structure 110 and/or manufactured in another manner. For example, the planar layer 134 can include a foil and the lattice structure is 3D printed on opposite sides of the foil.

In FIG. 4, a current collector 180 includes planar layers 184-1 and 184-2 and a lattice structure 182 between the planar layers 184-1 and 184-2. In some examples, additional lattice structures can be printed on outwardly facing surfaces of the planar layers 184-1 and 184-2.

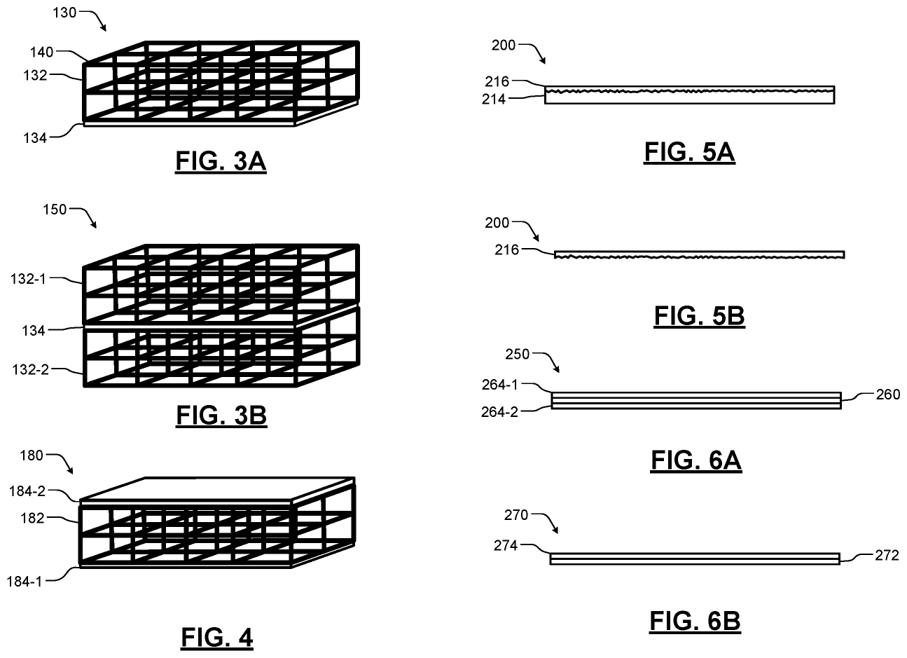

Referring now to FIGS. 5A to 5C, other methods for manufacturing the current collector are shown. In FIG. 5, the current collector 200 is metal 3D printed onto an exposed surface of a substrate 214. The exposed surface of the substrate 214 has with a predetermined profile to be transferred to the current collector 200. While a simple current collector layer is shown, more complex architectures such as those described above and/or below can be used. After metal 3D printing of the current collector 180, the substrate 184 can be removed. In some examples, the substrate 184 is water soluble or solvent soluble and is removed after the current collector 180 is printed using water or solvent, respectively. A facing surface of the current collector 200 is imprinted with a mirror image of the desired profile as shown in FIG. 5B.

Referring now to FIG. 6A, an electrode 250 includes a current collector 260 arranged between active material layers 264-1 and 264-2. After 3D printing the current collector 260, additional processing of the current collector 260 can be performed. For example, the current collector 260 can be further processed (e.g., coated, roughened or polished using chemical, heat, or mechanical treatment, heat treated, colored, laser coated with another material, etc.). After processing of the current collector 260 is completed, an active material layer (e.g., 264-1 and/or 264-2) can be coated or arranged on one or both sides of the current collector 100. The current collector 260 and the active material layer(s) 264-1 and/or 264-2 can be pressed and/or heated between rollers.

Referring now to FIG. 6B, a current collector 270 includes a metal 3D printed portion 274 (including L layers) arranged on a substrate 272. In some examples, the substrate 272 is selected from a group consisting of a plastic layer, a polymer layer, a metal layer (e.g., a foil, mesh, or expanded metal layer), a ceramic layer, a thin film, or other substrate. For example, the lattice structure can be printed on a polymer film. In some examples, the substrate provides mechanical support and allows the current collector to be self-standing, stored on a roll, and/or used in a roll to roll manufacturing process.

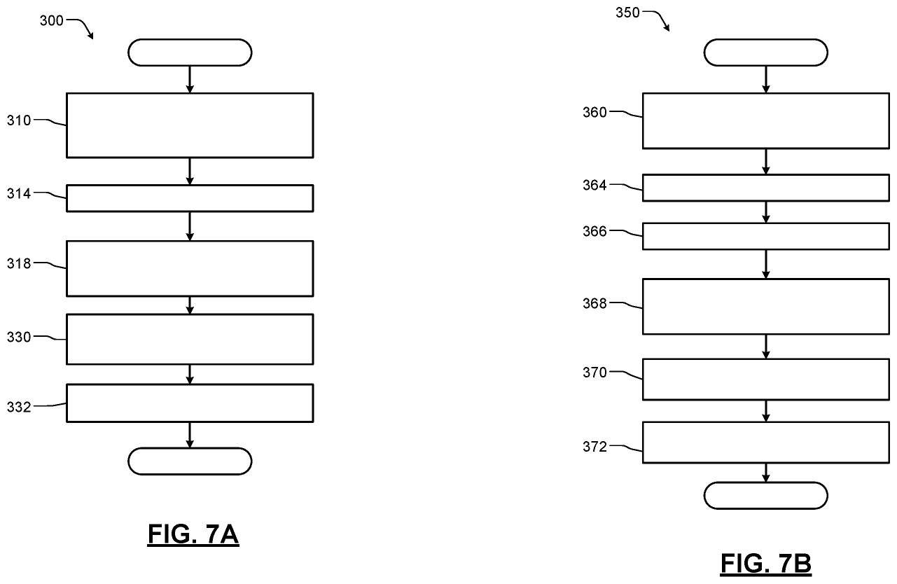

Referring now to FIG. 7A, a method 300 for manufacturing a current collector is shown. At 310, a current collector is metal 3D printed and includes a lattice structure. At 314, the current collector is optionally treated (e.g., coated, roughened or polished using chemical, heat, or mechanical treatment, heat treated, colored, laser coated with another material, etc.). At 318, an active material layer is coated or arranged on the current collector to form an electrode. At 320, the electrode including the active material layer and the current collector are pressed and/or heated using between rollers and/or press. At 322, the electrode is arranged in a battery cell.

Referring now to FIG. 7B, a method 350 for manufacturing a current collector is shown. At 360, a current collector is metal 3D printed onto a substrate. In some examples, the substrate has a predetermined profile to be transferred to a corresponding surface of the current collector. At 364, the substrate is optionally dissolved if desired (unless the substrate forms part of the current collector). In other examples, the substrate is not removed or dissolved and forms part of the current collector.

At 366, the current collector is optionally further processed (e.g., coated, roughened, or polished using chemical, heat, or mechanical treatment, heat treated, colored, coated with another material, laser heated, etc.). At 368, an active material layer is coated or arranged on the current collector to form an electrode. At 370, the electrode including the active material layer and the current collector are pressed and/or heated between rollers and/or a press. At 372, the electrode is arranged in a battery cell.

The current collectors according to the present disclosure can be manufactured with additional features, increased detail, and/or increased quality control/uniformity. More complex current collector architectures can be manufactured by finely controlling a physical shape or other attributes of a lattice structure of the current collector. Metal 3D printing enables the current collector to be made with multiple materials. Further, manufacturing parameters can be changed to allow rapid improvements to be made. The methods for manufacturing the current collector provides the ability to optimize battery properties such as capacity, charge rate, range, and/or current capacity using new current collector configurations and/or chemistries. Metal 3D printing produces less waste as compared to conventional manufacturing processes.

The methods for manufacturing current collectors provides the ability to manufacture precise current collectors for standardization that can be used for benchmarking, comparison, and/or battery development. The current collectors that are produced have unique identifiable surface designs or signatures can be easily detected with a profilometer microscope or other standard surface and/or chemical characterization techniques.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for manufacturing a current collector for an electrode of a battery cell, comprising:
forming the current collector using a metal 3D printing process;
defining L layers of the current collector, where L is an integer greater than zero during the 3D printing of the current collector; and
defining a lattice structure in at least one of the L layers of the current collector during the 3D printing of the current collector.

2. The method of claim 1, wherein the metal 3D printing process prints at least a portion of the current collector using one or more materials selected from a group consisting of copper, stainless steel, nickel, iron, titanium, tin, and/or alloys thereof.

3. The method of claim 1, wherein at least one of the L layers includes a planar layer, wherein at least another one of the L layers is printed on the planar layer.

4. The method of claim 1, wherein the current collector has a thickness in a range from 10 μm to 300 μm.

5. The method of claim 1, wherein the metal 3D printing process comprises electrochemical additive manufacturing (ECAM).

6. The method of claim 1, wherein the current collector comprises an anode current collector and the metal 3D printing process prints the current collector using at least one of copper and a copper alloy.

7. The method of claim 1, wherein the current collector includes a planar layer and the lattice structure includes a first lattice structure printed on one side of the planar layer and a second lattice structure printed on an opposite side of the planar layer.

8. The method of claim 1, further comprising coating the current collector with an active material layer to form one of an anode electrode and a cathode electrode.

9. The method of claim 8, further comprising at least one of pressing and heating the current collector and the active material layer.

10. The method of claim 1, wherein the metal 3D printing process prints at least a portion of the current collector using two or more metals selected from a group consisting of copper, stainless steel, nickel, iron, titanium, tin, and/or alloys thereof.

11. The method of claim 1, wherein the current collector is printed on a substrate.

12. The method of claim 11, wherein the substrate is selected from a group consisting of a polymer layer, a plastic layer, a metal layer, a ceramic layer, and a thin film.

13. The method of claim 11, wherein the substrate comprises foil.

14. A method for manufacturing a current collector for an electrode of a battery cell, comprising:
providing a substrate having a surface with a predetermined profile;
forming the current collector using a metal 3D printing process;
during the 3D printing of the current collector, defining L layers of the current collector, where L is an integer greater than zero;
during the 3D printing of the current collector, defining a lattice structure in at least one of the L layers of the current collector; and
dissolving the substrate.

15. The method of claim 14, wherein the metal 3D printing process prints at least a portion of the current collector using one or more materials selected from a group consisting of copper, stainless steel, nickel, iron, titanium, tin, and/or alloys thereof.

16. The method of claim 14, wherein at least one of the L layers includes a planar layer, wherein at least another one of the L layers is printed on the planar layer.

17. The method of claim 14, wherein the metal 3D printing process comprises electrochemical additive manufacturing (ECAM).

18. The method of claim 14, further comprising coating the current collector with an active material layer.

19. The method of claim 18, further comprising at least one of pressing and heating the current collector and the active material layer to form one of an anode electrode and a cathode electrode.

20. An anode electrode of a battery cell, comprising:
an anode current collector comprising L layers made of at least one of copper and copper alloy, where L is an integer greater than zero, wherein at least one of the L layers of the current collector includes a lattice structure formed using 3D metal printing; and
an anode active layer arranged on at least one side of the anode current collector.
